(19) United States
(12) Patent Application Publication
(10) Pub. No.: US 2018/0318055 A1
(43) Pub. Date: Nov. 8, 2018

(54) INTERPROXIMAL CARIES TREATMENT DEVICE AND METHOD

(71) Applicant: Kelly M. Lipp, Columbus, OH (US)

(72) Inventor: Kelly M. Lipp, Columbus, OH (US)

(21) Appl. No.: 15/974,568

(22) Filed: May 8, 2018

Related U.S. Application Data
(60) Provisional application No. 62/502,943, filed on May 8, 2017.

(51) Int. Cl. A61C 19/06

(52) U.S. Cl. CPC A61C 19/063

(57) ABSTRACT

An applicator and method for treating interproximal caries for applying a first topical substance and a second topical substance to an interproximal dental surface.

### RELATED U.S. PROVISIONAL APPLICATION

This application is based upon and claims the priority filing date of the previously filed, copending U.S. Provisional patent application entitled “INTERPROXIMAL CARIES TREATMENT DEVICE AND METHOD” filed May 8, 2017, Ser. No. 62/502,943, the entire disclosure of which is hereby incorporated herein by reference.

### FIELD OF THE INVENTION

The present invention relates to the field of dental medical devices, particularly with regard to an applicator for applying a topical substance for treatment of dental caries.

### BACKGROUND

Dental cavities are still a significant public health problem. Despite preventive oral hygiene measures, dental care remains one of the greatest unmet healthcare needs; 40% of individuals have cavities by age 5, and 92% of adults experience dental decay by age 64.

It is well-known that brushing and flossing prevent dental decay, but the spaces between the teeth are more difficult to properly clean, making the formation of cavities in these spaces much more likely. Cavities in between teeth are called “interproximal cavities” and are commonly found in patients who frequently consume sugar-sweetened beverages or high carbohydrate snacks.

Regular dental checkups easily detect interproximal cavities by using an X-ray called a bitewing. This type of X-ray allows the dentist to see the extent of the dental cavity.

If the decay has only extended into the outer layer of the tooth (“enamel”), it is called an “incipient” cavity. Incipient cavities can heal by improving oral hygiene, fluoride application or improving diet. However, once the cavity penetrates past the enamel and into the inner layer of the tooth (“dentin”), a filling is usually the appropriate treatment. If these cavities go untreated and continue to grow, more extensive dentistry could be necessary such as a crown, root canal, or even extraction.

Silver Diamine Fluoride (“SDF”) is a clinically applied treatment that controls active dental cavities and prevents further progression of the disease. SDF can heal (“remineralize”) incipient cavities, and can arrest deeper cavities that would otherwise require a conventional filling. The combination of ingredients found in SDF are dual acting—the silver component acts as an anti-microbial agent, while the fluoride acts to prevent further demineralization of tooth structure.

In current practices, the application of SDF is simple and non-invasive method for treating cavities on the chewing surface of the tooth (“occlusal surface”). Initially, the affected teeth are debrided, isolated, and dried. The teeth with cavities are then isolated from the remaining teeth and dried. Thereafter, a microbrush, is immersed in SDF and applied to the cavities for approximately 1 minute. Thereafter, excess SDF is removed and patients are instructed not to eat or drink for the following hour. Around 60% of occlusal surface cavities are arrested after a single application of SDF.

A problem with the use of SDF and other topical dental solutions is that it cannot easily and properly be applied to an interproximal dental surface due to the narrow space between the teeth and the risk of contaminating the SDF with saliva, or other fluids, accumulated in the interproximal space.

Presently, there is no device or method that efficiently and effectively treats interproximal cavities with SDF. Separators or elastic rings, which fit between the teeth and create a temporary interproximal space, can be placed before the SDF is applied with a microbrush to the interproximal tooth surface, but this treatment method requires at least two time-consuming visits to the dentist as the separators must sit between the teeth for several days before sufficient space is achieved. Separators can also cause trauma or discomfort to the patient's gums.

The current state of the art fails to teach or suggest an effective device which simplifies and accelerates the application and treatment of interproximal cavities utilizing SDF or other materials.

### SUMMARY

In accordance with the invention, an applicator for treating interproximal caries for applying a first topical substance and a second topical substance to an interproximal dental surface is provided. A version of the application may generally comprise a body assembly comprising: at least one receptacle for holding the first topical substance and the second topical substance; a head assembly operably attached to the body portion and operably communicating with the at least one receptacle, the head assembly comprising: a support frame having a buccal strut, an opposing lingual strut, and an occlusal strut connecting the buccal strut and the lingual strut; and a hydrophilic material or an equivalent material extending within the support frame. Ideally, the hydrophilic material is configured and sized to access the interproximal dental surface between the patient's teeth. At least one conduit for transferring the topical substance from the at least one receptacle to the hydrophilic material is provided.

In some versions, the first topical substance used within the applicator is preferably silver diamine fluoride and the second topical substance used within the applicator is preferably fluoride varnish.

In a certain version, the body comprises a first receptacle for holding the first topical substance and a second receptacle for holding the second topical substance; and a first conduit for transferring the first topical substance from the first receptacle to the hydrophilic material and a second conduit for transferring the second topical substance from the second receptacle to the hydrophilic material.

In yet other versions, the first receptacle may comprise a compressible cartridge, initially sealed, having a downstream end. The downstream end has a discharge valve operably configured to open when the compressible cartridge is compressed. The second receptacle may include a barrel defining an axis and a plunger which is configured to slidably engage within the barrel along the axis and discharge the second topical substance therein upon actuation.

In another embodiment of the application, the at least one receptacle for holding the first topical substance downstream and the second topical substance upstream comprises a barrel defining an axis and a plunger which is configured to slidably engage within the barrel along the axis. The barrel has a barrier membrane which separates the first substance downstream from the second substance upstream. The plunger moves through a first range of movement, discharging the downstream first topical substance to the hydrophilic material, and a second range of movement, breaking the barrier membrane and discharging the second topical substance to the hydrophilic material.

In another more detailed version of the application, an applicator for treating interproximal caries for applying a first topical substance and a second topical substance to an interproximal dental surface is provided. The detailed version of the applicator generally has a body assembly comprising: a first receptacle for storing the first topical substance, a first receptacle comprising a compressible cartridge, initially sealed, having a downstream end, the downstream end having a discharge valve operably configured to open when the compressible cartridge is compressed. A second receptacle is provided for storing a quantity of the second topical substance. The second receptacle generally includes a barrel defining an axis and a plunger which is configured to slidably engage within the barrel along the axis and discharge the second topical substance therein. Further, a head assembly is operably attachably removable to the body assembly and operably communicating with the first and second receptacles. The head assembly may include a support frame having a buccal strut, an opposing lingual strut, and an occlusal strut connecting the buccal strut and the lingual strut; and a thin hydrophilic material extending within the support frame defining an outer periphery and an exposed bottom perimeter. The thin hydrophilic material is configured and sized to access the interproximal dental surface between the patient's teeth. A first conduit is provided for transferring the first topical substance from the first receptacle to the hydrophilic material. The first conduit generally has an upstream end communicating with the first receptacle and a downstream end communicating with the periphery of the hydrophilic material. Further, a second conduit is provided for transferring the second topical substance from the second receptacle to the hydrophilic material. The second conduit having an upstream end communicating with the downstream end of the second receptacle and a downstream end communicating with the periphery of the hydrophilic material.

In some versions of the application, the compressible cartridge is detachable and interchangeable from the applicator.

In other versions, the applicator may further boast a bite plate having an upward exposed surface operably positioned on the head assembly above the hydrophilic material.

In yet other embodiments, the applicator may further include a first pad positioned exterior of the lingual strut and a second pad positioned exterior of the buccal strut.

These and other features of the present invention will become readily apparent upon further review of the following specification and drawings.

### BRIEF DESCRIPTION OF THE DRAWINGS

These and other features, aspects, and advantages of the present invention will become better understood with regard to the following description and accompanying figures where:

FIG. 1 is a left-side perspective view showing a version of the application;

FIG. 2 is a right-side elevation view of the version shown in FIG. 1;

FIG. 3 is a left-side elevation view of the version shown in FIG. 1;

FIG. 4 is a top plan view of the version shown in FIG. 1;

FIG. 5 is a bottom plan view of the version shown in FIG. 1;

FIG. 6 is a left-side disassembled view of the version shown in FIG. 1;

FIG. 7 is an up-close cross-sectional view taken along the lines A-A shown in FIG. 6;

FIG. 8 is an up-close cross-sectional view taken along the lines B-B shown in FIG. 6;

FIG. 9 is a left-side view illustrating an alternative head assembly size of the version shown in FIG. 1;

FIG. 10 is an illustrative perspective view showing use of the version shown in FIG. 1;

FIG. 11 is an illustrative perspective view showing use of the version shown in FIG. 1;

FIG. 12 is an illustrative left-side cross-sectional view showing operation of the version shown in FIG. 1;

FIG. 13 is an illustrative perspective view showing use of the version shown in FIG. 1;

FIG. 14 is an illustrative perspective view showing operation of the version shown in FIG. 1;

FIG. 15 is an illustrative left-side cross-sectional view showing operation of the version shown in FIG. 1;

FIG. 16 is an illustrative perspective view showing use of the version shown in FIG. 1;

FIG. 17 is an example illustrating a plurality of prepackaged disposable compressible cartridges;

FIG. 18 is a left-side view showing a second version providing dual plungers;

FIG. 19a is a left-side cross-sectional view showing a third version utilizing a membrane forming a barrier;

FIG. 19b is a left-side cross-sectional view showing a third version utilizing a membrane forming a barrier of the version shown in FIG. 19a; and

FIG. 19c is a left-side cross-sectional view showing a third version utilizing a membrane forming a barrier of the version shown in FIG. 19a.

### DETAILED DESCRIPTION

In the following description, for purposes of explanation and not limitation, specific details are set forth such as particular architectures, interfaces, techniques, etc. in order to provide a thorough understanding of the present invention. However, it will be apparent to those skilled in the art that the present invention may be practiced in other versions that depart from these specific details. In other instances, detailed descriptions of well-known devices and methods are omitted so as not to obscure the description of the present invention with unnecessary detail.

The following detailed description is of the best currently contemplated modes of carrying out exemplary versions of the invention. The description is not to be taken in the limiting sense, but is made merely for the purpose illustrating the general principles of the invention, since the scope of the invention is best defined by the appended claims. Various inventive features are described below that can each be used independently of one another or in combination with other features.

Referring now to the figures wherein the showings are for purposes of illustrating a preferred version of the invention only and not for purposes of limiting the same, the present application discloses an applicator for treating patients having interproximal caries with two or more topical substances such as silver diamine fluoride (SDF) or other cavity-treating substance such as silver nitrate and a fluoride varnish or other flavor masking agent as well as the method of use thereof.

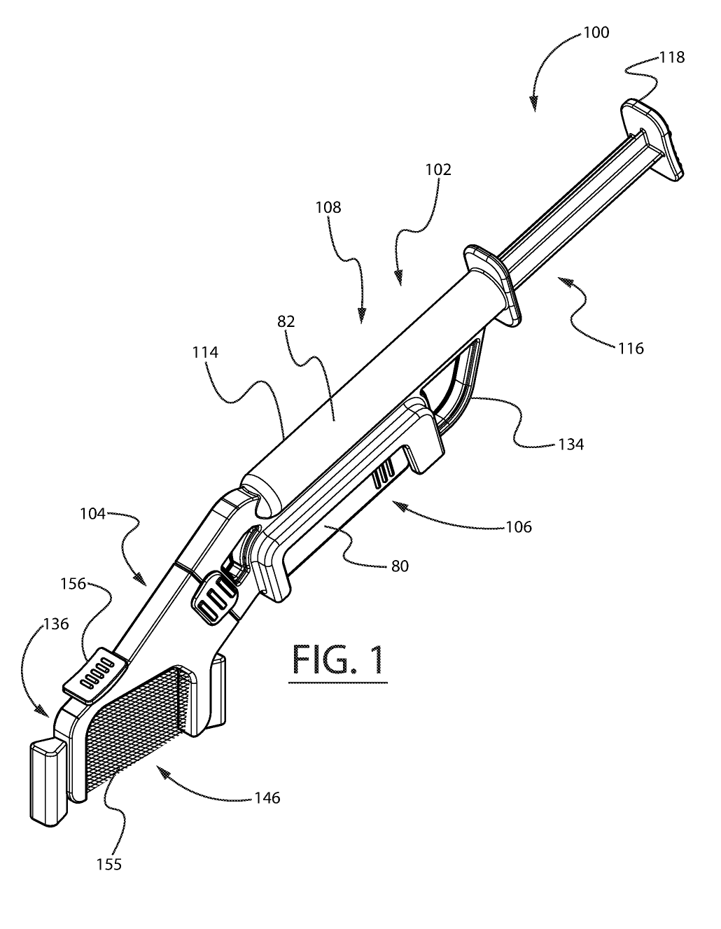

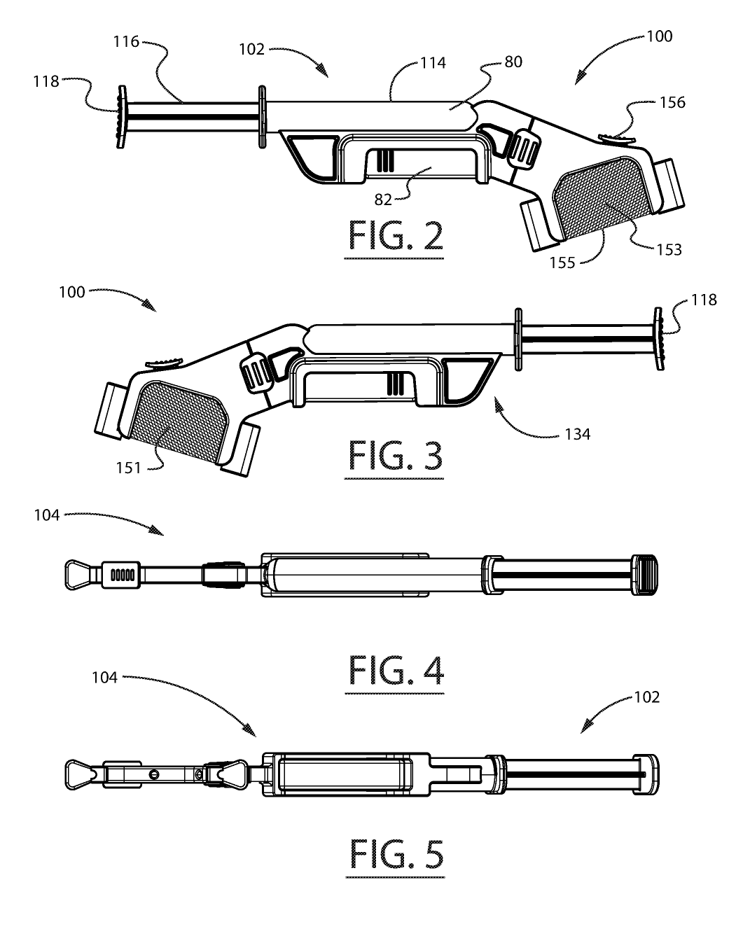

Referring generally to FIG. 1-FIG. 6, a version of the applicator is described for use with a first topical substance 80 and a second topical substance 82 for the treatment of interproximal dental caries and is generally designated by the numeral 100. As illustrated, the applicator 100 generally comprises a body assembly 102 for storing the first and second topical substances 80, 82 prior to application; and a head assembly 104 for applying the first and second topical substances 80, 82 directly to the patient's teeth which is operably attached to the body portion and operably communicating with the first and second topical substances 80, 82.

The body assembly 102 generally comprises a first receptacle 106 for storing the first topical substance 80 and the second receptacle 108 for storing the second topical substance 82 prior to application. Preferably, the first and second receptacles 106, 108 are positioned along parallel axis extending between an upstream end 110 towards a downstream end 112 of the body assembly 102. Preferably, the first and second receptacles 106, 108 are positioned in a stack formation—the second receptacle 108 positioned above and parallel with first receptacle 106 (See FIG. 3).

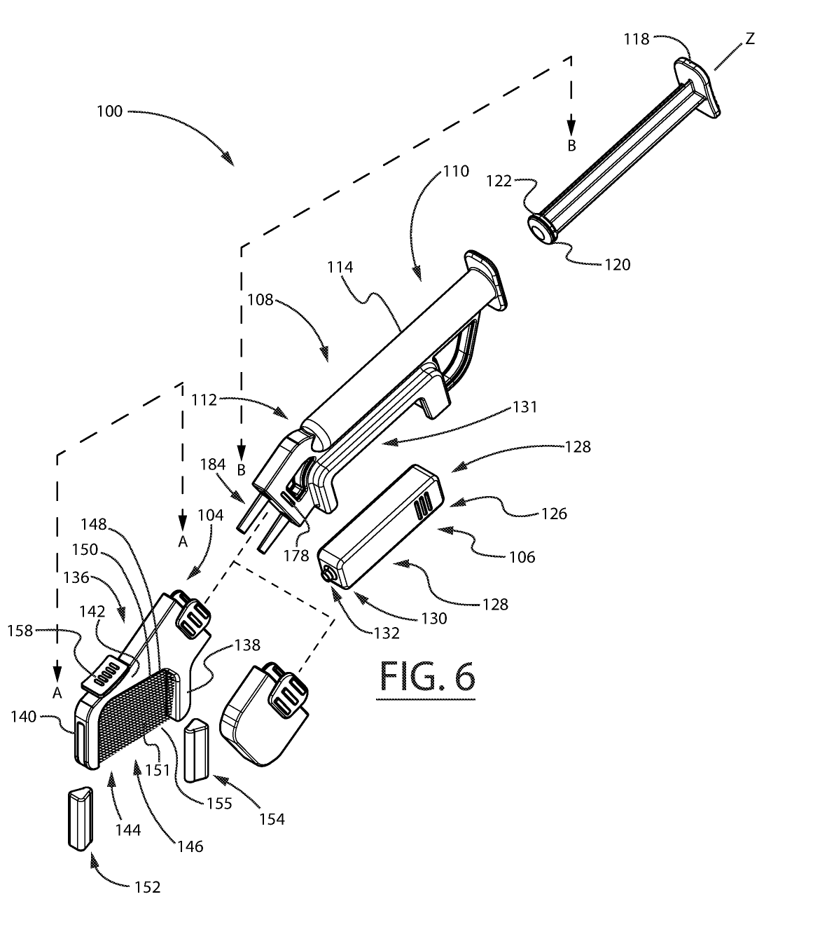

As best illustrated in FIG. 3 and FIG. 6, the first receptacle 106 generally comprises a squeezable or compressible cartridge 126 otherwise known as a blister pack operably configured to store and seal the first topical substance 80 prior to the application process, which ideally is SDF or an equivalent. The blister pack 126 is ideally shaped and sized to provide a one-time application of SDF and is disposable after each use. The compressible cartridge 126 is sized to fit in a slot 131 which is sized and shaped to receive and seat the cartridge therein (FIG. 6). The cartridge 126 includes an upstream end 128 and a downstream end 130 having a discharge valve 132 which opens when the cartridge 126 is compressed or squeezed. Thus, preferably, prior to the application process of the first topical substance 80, the cartridge 126 is completely sealed containing the first topical substance 80 therein. After the cartridge 126 is squeezed during the application process, the discharge valve 132 is caused to be opened or unsealed due to pressure buildup causing the first topical substance 80 to move from the upstream end 128 to the downstream end 130.

In the illustrated version, the second receptacle 108 is generally a syringe type reciprocating pump comprised of a barrel 114 defining an axis and a plunger 116 which is configured to slidably fit and engage within the barrel along the axis in order to discharge the second topical substance 82 within the barrel 114, which ideally is a fluoride varnish or an equivalent. The second receptacle 108 barrel 114 is ideally shaped and sized to provide a volume of fluoride varnish which is sufficient for a plurality of applications—thereby provide a larger volume than the one-time use blister packs first receptacles 106.

In the version, the plunger 116 extends between a flange 118 and terminates downstream at a piston 120 including a seal 122. The barrel 114 is a cylindrical tube operably configured to store the second topical substance 82 prior to application having an open upstream end 110 and a closed downstream end 112. The closed downstream end 112 having an injection port 124.

By way of operation, the plunger 116 is linearly and slidably pulled and pushed along the interior of the barrel 114 by way of the open upstream end 110 allowing the second receptacle 108 to expel the second topical substance 82 downstream through the injection port 124 (See FIG. 8).

As best illustrated in FIG. 3, certain versions of the application may further comprise a finger flange 134 for providing leverage during the application process of the second receptacle 108 resembling a syringe configuration. Thus, the index finger is placed in and forward of the flange 134 while the thumb depresses the plunger flange 118.

Generally, the head assembly 104 is operably attached downstream or forward of the body assembly 102 and operably communicates with the first and second receptacles 106, 108 in order to receive and apply the first and second topical substances 80, 82 to the patient's affected area pertaining to interproximal caries.

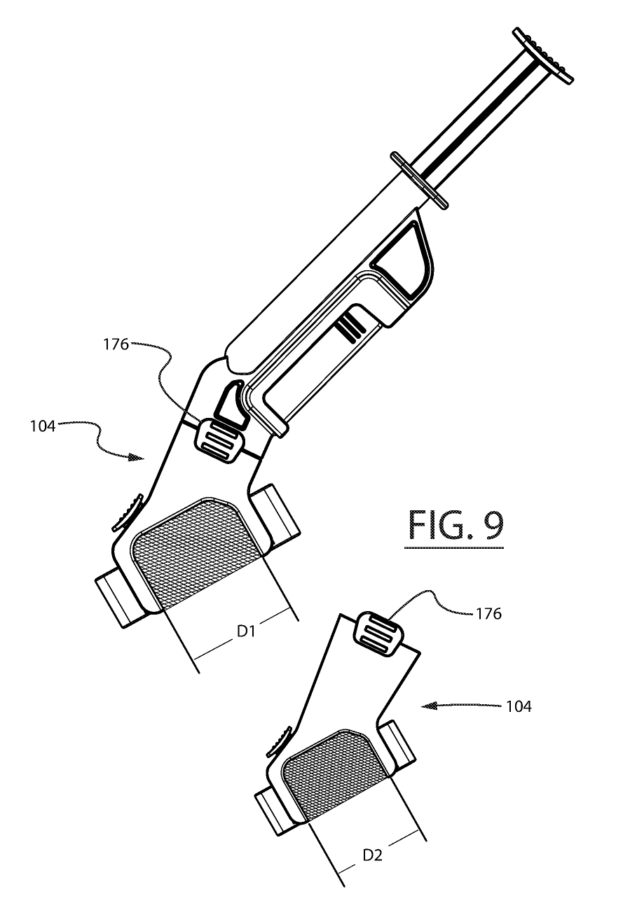

As best illustrated by FIG. 1 and FIG. 6, the head assembly 104 generally comprises a hydrophilic material 146 suspended within a support frame 136. In the version, the support frame 136 has a buccal strut 138, an opposing lingual strut 140, and an occlusal strut 142. The occlusal strut 142 extends between and connects the buccal strut 138 with the lingual strut 140 forming an arched configuration providing a bottom gap 144 defined by an exposed perimeter 155 having a width D₁ (See FIG. 9). Ideally, the width D₁ of the hydrophilic material 146 is between 12 mm-30 mm, preferably 25 mm. However, other dimensions can certainly be envisioned to better accommodate different tooth sizes, for examples sizes fitted for primary teeth (See D₂ in FIG. 9). Moreover, the thickness of the hydrophilic material 146 is preferably smaller than 0.25 mm. Preferably, the exposed perimeter 155 is angled relative to the body assembly 102 axis Z.

The hydrophilic material 146 laterally extends within the support frame 136 arched configuration and has an outer periphery 150 defined by the support frame 136 inner perimeter 148. Further, the hydrophilic material 146 comprises opposing application surfaces 151, 153 for receipt and distribution of the topical substances to the interproximal dental surface 38 during the application process. The hydrophilic material 146 is configured and sized to floss between and access the interproximal dental surface between the patient's teeth. The hydrophilic material can be any material that absorbs the topical substances and provides opposing application surfaces 151, 153.

Generally, the support frame 136 is sized to properly extend from the buccal side (cheek) to the lingual (tongue) side of the patient's teeth—spanning the interproximal dental surface formed between two adjacent teeth. The lingual strut 140 is shaped and configured to protect the lingual side of the patient's mouth from the topical substances during application. Similarly, the buccal strut 138 is shaped and configured to protect the buccal (cheek) side of the patient's mouth from the topical substances during application. In a version of the application, as best illustrated by FIG. 1 and FIG. 6, the head assembly 104 may further include a first pad 152 positioned exterior of the lingual strut 140 and a second pad 154 positioned exterior of the buccal strut 138.

Further, the head assembly 104 may comprise bite plate 156 which provides an upwardly exposed surface 158 positioned operably above the hydrophilic material 146. The bite plate 156 assists during seating of the head assembly 104 and hydrophilic material 146 between the patient's teeth by allowing the operator to place digital pressure upon the bite plate 156 or the patient to depress upon the bite plate 156 with their opposing teeth. Preferably, the bite plate 156 is operable positioned above the occlusal strut 142 and forward of center of the head assembly 104.

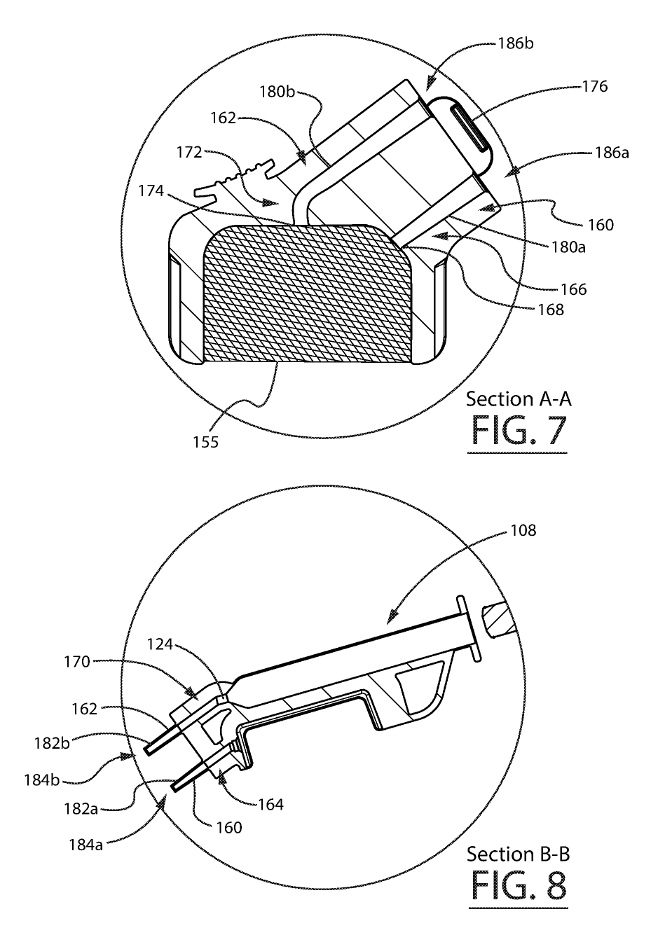

As best illustrated by up-close FIG. 7 and FIG. 8, the head assembly 104 is configured to communicate and receive the first and second topical substances 80, 82 from the body assembly 102 during the application process. In the version, a first conduit 160 allows the first topical substance 80 to transfer from the first receptacle 106 to the hydrophilic material 146 and a second conduit 162 allows the second topical substance 82 to transfer from the second receptacle 108 to the hydrophilic material 146.

The first conduit 160 has an upstream end 164 which communicates with the first receptacle 106 discharge valve 132 and a downstream end 166 which terminates at a first discharge orifice 168 which operably communicates with the outer periphery 150 of the hydrophilic material 146 near where the intersection of the occlusal strut 142 with the buccal strut 138. Thus, during application and discharge of the first topical substance 80, the first conduit 160 provides a channel for the first topical substance 80 to move from the first receptacle 106 to the hydrophilic material 146 throughout compression of the compressible cartridge 126, thus saturating the hydrophilic material 146 with the first topical substance 80. Preferably, the first topical substance 80 is silver diamine fluoride; however, other substances can certainly be utilized.

The second conduit 162 has an upstream end 170 which communicates with the second receptacle 108 injection port 124 and a downstream end 172 which terminates at a second discharge orifice 174 which operably communicates with the outer periphery 150 of the hydrophilic material 146 near the center of the occlusal strut 142. Thus, during application and discharge of the second topical substance 82, the second conduit 162 provides a channel for the second topical substance 82 to move from the second receptacle 108 to the hydrophilic material 146 throughout the plunger 116 range of linear movement, thus saturating the hydrophilic material 146 with the second topical substance 82.

In certain versions of the application the head assembly 104 is operably detachable from the body assembly 102. In the illustrated version, as best illustrated by FIG. 6-FIG. 9, the head assembly 104 is configured to secure and engage with the body assembly 102 by way of opposing clips 176 fixedly attached to the upstream side of the head assembly 104 which connect and couple with reciprocating slots 178 positioned at the downstream end of the body assembly 102. Further, each of the first and second conduits 160, 162 are designed to operably separate into a head assembly segment 180a, 180b and a body assembly segment 182a, 182b. The body assembly segments 182a, 182b form laterally projecting nozzles 184a, 184b and the head assembly segments 180a, 180b provide sockets 186a, 186b which are configured to operably receive, seat and seal with the laterally projecting conduits forming together the continuous first and second conduits 160, 162.

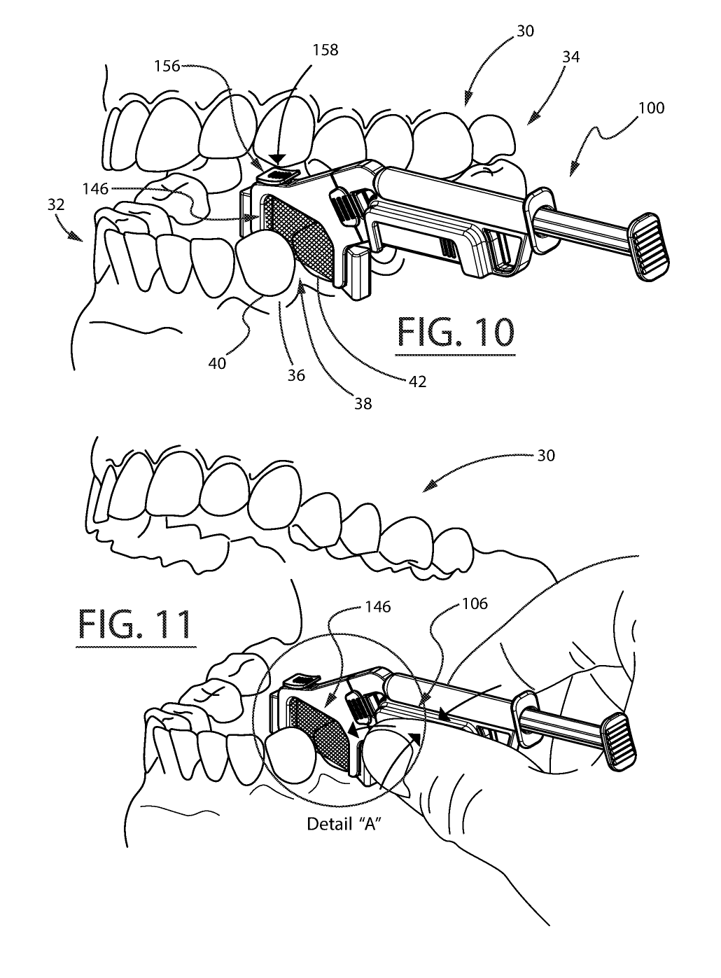

Referring now to FIG. 10-FIG. 16, a method utilizing the applicator 100 will now be described in detail relating to the mouth replica 30. The mouth replica 30 showing a bottom row of teeth 32, a top row of teeth 34, and adjacent gums 36. The method for treating interproximal caries utilizes silver diamine fluoride (SDF) as the first topical substance 80 and a fluoride varnish as the second topical substance 82 or equivalent. Per the description above and in preparation for use of the applicator 100, the body assembly 102 is equipped with the first receptacle 106 filled with an effective amount of SDF and the second receptacle 108 filled with an effective amount of fluoride varnish. Preferably, the effective amount of fluoride varnish per tooth is approximately 1 ml or about 5 ml for multiple teeth and the effective amount of SDF is approximately 1 drop or 0.05 ml per tooth or interproximal caries.

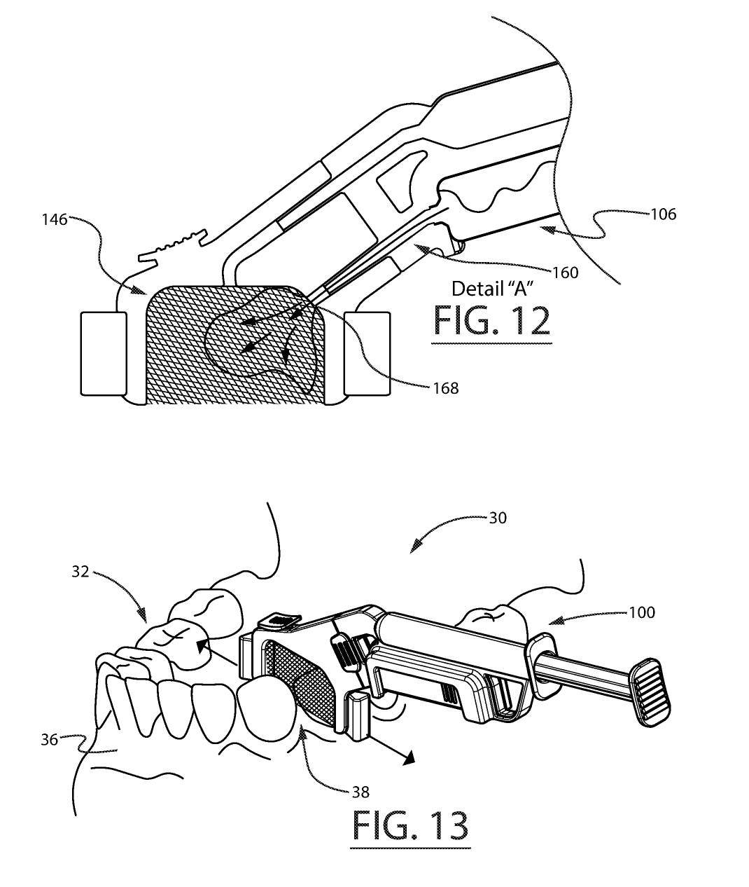

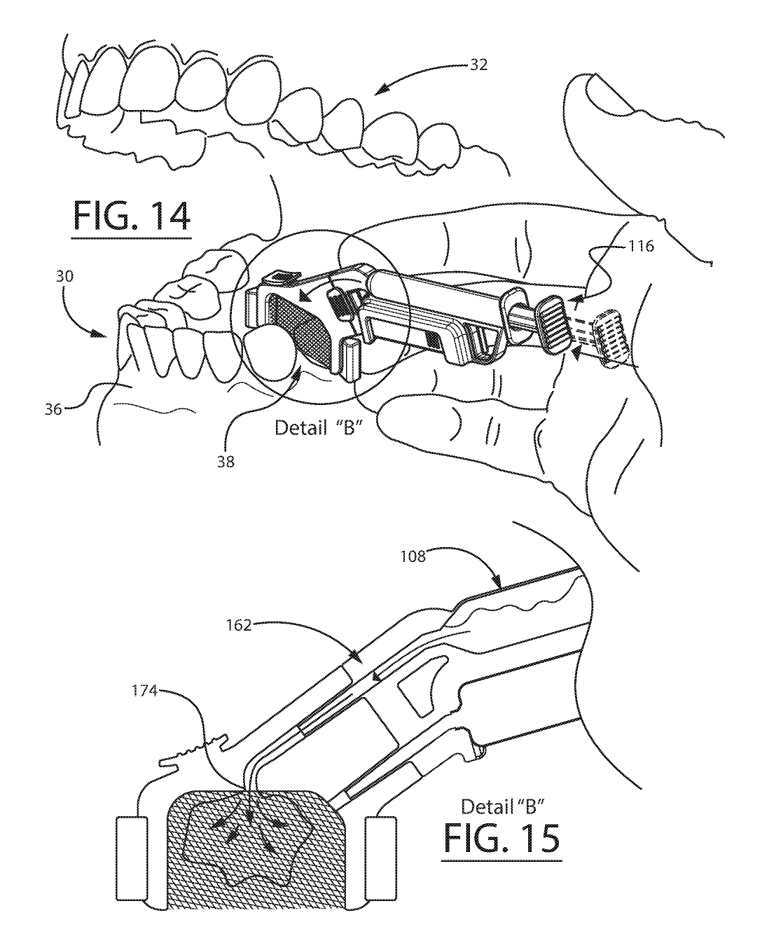

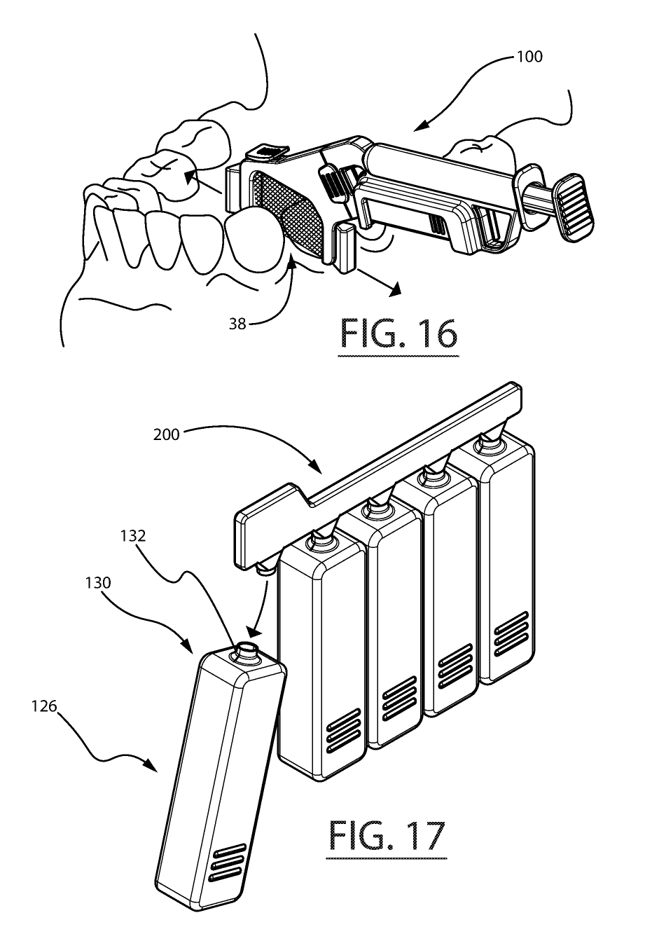

Initially, the gingival tissues or gums 36 are prepared by applying petroleum jelly to surrounding the affected interproximal dental surfaces 38. Next, the interproximal dental surfaces 38 positioned between adjacent first and second teeth 40, 42 are thoroughly cleaned and dried. Thereafter, the applicator 100 head assembly is positioned in the patient's mouth 30 and the hydrophilic material 146 is flossed between the adjacent first and second teeth 40, 42 near the interproximal dental surfaces 38 (See FIG. 10). The patient may assist with the flossing action by pressing down on the bite plate 156 with the opposing row of teeth 34 in order to wedge the hydrophilic material 146 between the teeth and into the interproximal dental surface area 38. Next, the SDF is transferred to and completely saturates the hydrophilic material 146 by compressing or squeezing the first receptacle 106—forcing the SDF to move from the first receptacle 106 to the hydrophilic material 146 via the first conduit 160 (See FIG. 11 and FIG. 12). Thereafter, the applicator 100 is translated forward and rearward tangential to the patient's teeth 30 and parallel to the interproximal dental surfaces 38—sufficiently contacting and applying the SDF to the interproximal caries (See FIG. 13). Next, the fluoride varnish is transferred from the second receptacle 108 to the hydrophilic material 146 via the second conduit 162 by moving the plunger 116 through the linear range of movement (See FIG. 14 and FIG. 15). Thereafter, the fluoride varnish 82 is applied to the interproximal dental surfaces 38 improving the overall taste by mitigating the undesirable flavor of the SDF by translating forward and rearward tangential to the patient's teeth 30 and parallel to the interproximal dental surfaces 38 (See FIG. 16).

The applicator 100 can be made in any manner and of any material chosen with sound engineering judgment. Preferably, materials will be strong, lightweight, long lasting, economic, ergonomic, and buoyant. Ideally, the head assembly 104 is manufactured to be disposable after each use. Thus, a plurality of head assemblies 104 can be utilized throughout the life of the body assembly 102.

Referring to FIG. 17, the first receptacles 106 or blister packs 126 may be pre-packaged in order to easily store the SDF in bulk prior to each applicator 100 use. In the version, the packaging provides a support array 200 connecting each blister pack 126 at the downstream end 130 discharge valve 132, wherein each individual blister pack 126 can be individually broken off from the support array 200 prior to each use.

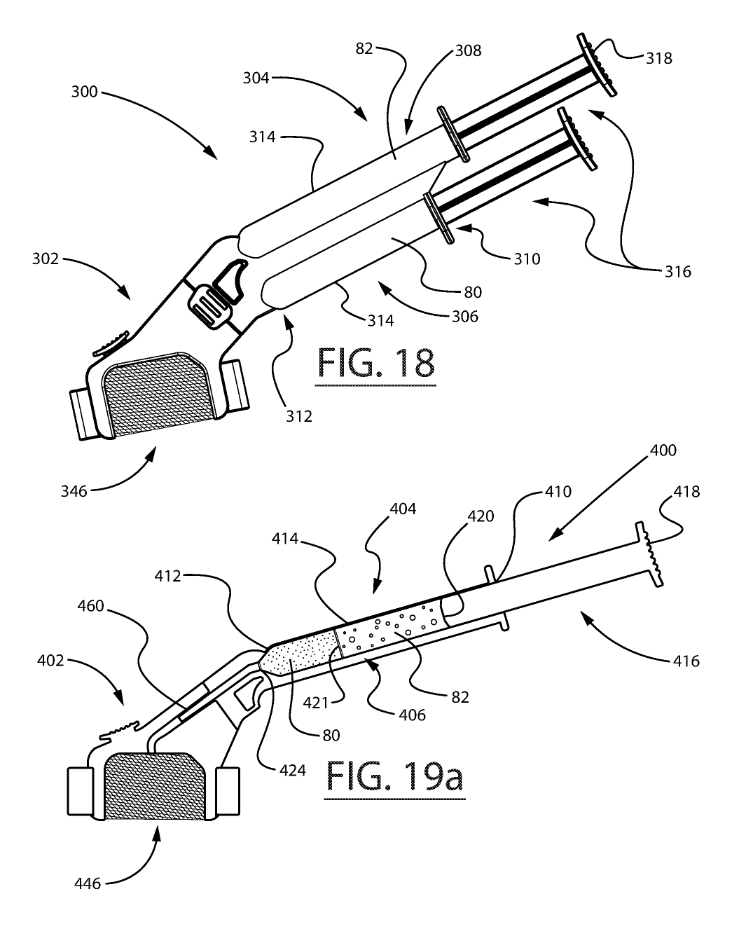

Referring to FIG. 18, an alternative second version of the application is provided generally designated by numeral 300. The second version 300 comprises a head assembly 302 and a body assembly 304. The differences between the first version 100 and the second version 300 residing in the configuration of the first receptacle 306 containing the first topical substance 80, typically SDF. As opposed to the blister pack 126 provided in the first version 100, the first receptacle 306 is similar in construction and nature to that of the second receptacle 108 provided in the first version 100 forming a dual syringe configuration. Generally, both the first and second receptacles 306, 308 are a syringe type reciprocating pump comprised of a barrel 314 defining an axis and a plunger 316 which is configured to slidably fit and engage within the barrel 314 along the axis in order to discharge contents held within each barrel 314. In the version, the plungers 316 extends between a flange 318 and terminates downstream at a piston—as shown in FIG. 6 of version 100 including a seal. The barrels 314 are a cylindrical tube operably configured to store the first topical substance 80 and the second topical substance 82 prior to application having an open upstream end 310 and a closed downstream end 312. The closed downstream end 312 having an injection port.

By way of operation, the plungers 316 are linearly and slidably pulled and pushed along the interior of the barrels 314 by way of the open upstream end 310 allowing the first receptacle 306 to expel the first topical substance 80 downstream through the injection port via the conduit to the hydrophilic material 346 and the second receptacle 308 to expel the second topical substance 82 downstream through the respective injection port via the conduit to the hydrophilic material 346 (Similar as described above regarding the second receptacle 108 of the applicator 100).

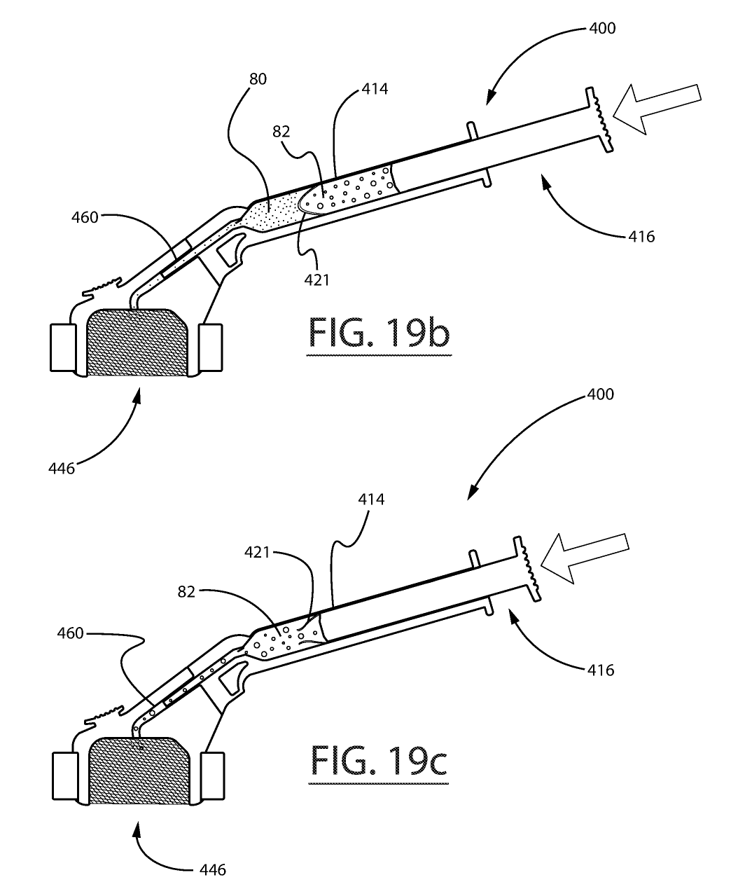

As best illustrated in FIG. 19a-FIG. 19c, a third version of the application is disclosed which provides a single receptacle for containing both the first and second topical substances 80, 82 and is generally designated by numeral 400. In the illustrated version, the applicator 400 generally comprises a head assembly 402 as described above in version 100 and a body assembly 404 having a single receptacle 406 containing the first topical substance 80 downstream, typically SDF, and the second topical substance 82, typically fluoride varnish, positioned upstream of the first topical substance 80 separated by a barrier membrane 421.

Generally, the receptacle 406 is a syringe type reciprocating pump comprised of a barrel 414 defining an axis and a plunger 416 which is configured to slidably fit and engage within the barrel 414 along the axis in order to discharge contents held within the barrel 414. In the version, the plungers 416 extends between a flange 418 and terminates downstream at a piston 420. The barrels 414 is a cylindrical tube operably configured to store the first topical substance 80 and the second topical substance 82 separated by the barrier membrane 421 prior to each application thereof. Further the barrel 414 has an open upstream end 410 and a closed downstream end 412 having an injection port 424.

By way of operation, the plungers 416 is linearly and slidably pulled and pushed along the interior of the barrels 414 by way of the open upstream end 410 through a first range of movement (FIG. 19b) expelling the first topical substance 80 via the conduit 460 to the hydrophilic material 446 and a second range of movement (FIG. 19c) expelling the second topical substance 82 via the conduit 460 to the hydrophilic material 446. As the plunger is caused to move through the first range of movement (FIG. 19b), the barrier membrane 421 deforms and stretches downstream maintaining a barrier between the first and second topical substances 80, 82 as the first topical substance 80 moves downstream through the injection port 424 to the conduit 460 and finally reaching the hydrophilic material 446. The barrier membrane 421 is configured to break under pressure once the plunger 416 reaches the beginning of the second linear range of movement (FIG. 19c)—allowing the second topical substance to move downstream through the injection port 424 to the conduit 460 and finally reaching the hydrophilic material 446 during the application process.

The invention does not require that all the advantageous features and all the advantages need to be incorporated into every version of the invention.

Although preferred embodiments of the invention have been described in considerable detail, other versions and embodiments of the invention are certainly possible. Therefore, the present invention should not be limited to the described embodiments herein.

All features disclosed in this specification including any claims, abstract, and drawings may be replaced by alternative features serving the same, equivalent or similar purpose unless expressly stated otherwise.

What is claimed is:

1. An applicator for treating interproximal caries for applying a first topical substance and a second topical substance to an interproximal dental surface, the applicator comprising:
a) a body assembly comprising:
i) at least one receptacle for holding the first topical substance and the second topical sub stance;
b) a head assembly operably attached to the body assembly and operably communicating with the at least one receptacle, the head assembly comprising:
i) a support frame having a buccal strut, a lingual strut, and an occlusal strut connecting the buccal strut and the lingual strut; and
ii) a hydrophilic material extending within the support frame, the hydrophilic material configured and sized to access the interproximal dental surface; and
c) at least one conduit for transferring the first topical substance and the second topical substance from the at least one receptacle to the hydrophilic material.

2. The applicator of claim 1, wherein the body assembly comprises a first receptacle for holding the first topical substance and a second receptacle for holding the second topical substance; and a first conduit for transferring the first topical substance from the first receptacle to the hydrophilic material and a second conduit for transferring the second topical substance from the second receptacle to the hydrophilic material.

3. The applicator of claim 2, wherein the first receptacle comprises a compressible cartridge, initially sealed, having a downstream end, the downstream end having a discharge valve operably configured to open when the compressible cartridge is compressed.

4. The applicator of claim 3, wherein the second receptacle comprises a barrel defining an axis and a plunger which is configured to slidably engage within the barrel along the axis and discharge the second topical substance therein upon actuation.

5. The applicator of claim 1, wherein the at least one receptacle comprises a barrel defining an axis and a plunger which is configured to slidably engage within the barrel along the axis, the barrel having a barrier membrane which separates the first topical substance downstream from the second topical substance upstream, wherein the plunger moves through a first range of movement, discharging the downstream first topical substance to the hydrophilic material, and a second range of movement, breaking the barrier membrane and discharging the second topical substance to the hydrophilic material.

6. The applicator of claim 5, further comprising a first conduit for transferring the first topical substance and the second topical substance from the first receptacle to the hydrophilic material throughout the first range of movement and second range of movement.

7. The applicator of claim 1, wherein the first topical substance is silver diamine fluoride and the second topical substance is a fluoride varnish.

8. The applicator of claim 1, further comprising a bite plate having an upward exposed surface operably positioned on the head assembly above the hydrophilic material.

9. The applicator of claim 1, further comprising a first pad positioned exterior of the lingual strut and a second pad positioned exterior of the buccal strut.

10. An applicator for treating interproximal caries for applying a first topical substance and a second topical substance to an interproximal dental surface, the applicator comprising:
a) a body assembly comprising:
i) a first receptacle for holding the first topical substance;
ii) a second receptacle for holding the second topical substance, the second receptacle comprising a barrel defining an axis and a plunger which is configured to slidably engage within the barrel along the axis and discharge the second topical substance therein; and
b) a head assembly operably attached to the body assembly and operably communicating with the first and second receptacles, the head assembly comprising:
i) a support frame having a buccal strut, an lingual strut, and an occlusal strut connecting the buccal strut and the lingual strut a gap; and
ii) a hydrophilic material extending within the support frame, the hydrophilic material configured and sized to access the interproximal dental surface between the patient's teeth;
c) a first conduit for transferring the first topical substance from the first receptacle to the hydrophilic material; and
d) a second conduit for transferring the second topical substance from the second receptacle to the hydrophilic material.

11. The applicator of claim 10, wherein the first receptacle comprises a compressible cartridge, initially sealed, having a downstream end, the downstream end having a discharge valve operably configured to open when the compressible cartridge is compressed.

12. The applicator of claim 11, wherein the compressible cartridge is operably detachable from the applicator.

13. The applicator of claim 10, wherein the first topical substance is silver diamine fluoride and the second topical substance is a fluoride varnish.

14. The applicator of claim 10, further comprising a bite plate having an upward exposed surface operably positioned on the head assembly above the hydrophilic material.

15. The applicator of claim 14, further comprising a first pad positioned exterior of the lingual strut and a second pad positioned exterior of the buccal strut.

16. An applicator for treating interproximal caries for applying a first topical substance and a second topical substance to an interproximal dental surface, the applicator comprising:
a) a body assembly comprising:
i) a first receptacle for storing the first topical substance, the first receptacle comprising a compressible cartridge, initially sealed, having a downstream end, the downstream end having a discharge valve operably configured to open when the compressible cartridge is compressed;
ii) a second receptacle for storing a quantity of second topical substance having a greater volume than the first receptacle, the second receptacle comprising a barrel defining an axis and a plunger which is configured to slidably engage within the barrel along the axis and discharge the second topical substance therein; and
b) a head assembly operably attachably removable to the body assembly and operably communicating with the first and second receptacles, the head assembly comprising:
i) a support frame having a buccal strut, an opposing lingual strut, and an occlusal strut connecting the buccal strut and the lingual strut; and
ii) a hydrophilic material extending within the support frame defining an outer periphery and an exposed bottom perimeter, the thin hydrophilic material configured and sized to access the interproximal dental surface between the patient's teeth;
c) a first conduit for transferring the first topical substance from the first receptacle to the hydrophilic material, the first conduit having an upstream end communicating with the first receptacle and a downstream end communicating with the periphery of the hydrophilic material; and
d) a second conduit for transferring the second topical substance from the second receptacle to the hydrophilic material, the second conduit having an upstream end communicating with the downstream end of the second receptacle and a downstream end communicating with the periphery of the hydrophilic material.

17. The applicator of claim 16, wherein the first topical substance is a silver diamine fluoride and the second topical substance is fluoride varnish.

18. The applicator of claim 16, wherein the compressible cartridge is detachable and interchangeable from the applicator.

19. The applicator of claim 16, further comprising a bite plate having an upward exposed surface operably positioned on the head assembly above the hydrophilic material.

20. The applicator of claim 19, further comprising a first pad positioned exterior of the lingual strut and a second pad positioned exterior of the buccal strut.
